(19) United States
(12) Patent Application Publication
(10) Pub. No.: US 2023/0129561 A1
(43) Pub. Date: Apr. 27, 2023

(54) METHODS OF MAKING A THREE-DIMENSIONAL OBJECT

(71) Applicant: CARBON, INC., Redwood City, CA (US)

(72) Inventor: Justin Poelma, Sunnyvale, CA (US)

(21) Appl. No.: 17/906,539

(22) PCT Filed: Apr. 26, 2021
(86) PCT No.: PCT/US2021/029122

§ 371 Date: Sep. 16, 2022

Related U.S. Application Data
(60) Provisional application No. 63/016,557, filed on Apr. 28, 2020.

(51) Int. Cl. C09D 4/00; B29C 64/124; B29C 64/35; B29C 64/295; B33Y 10/00; B33Y 30/00; B33Y 40/20; B33Y 70/00; C08F 232/08; C09D 145/00

(52) U.S. Cl. CPC C09D 4/00; B29C 64/124; B29C 64/35; B29C 64/295; B33Y 10/00; B33Y 30/00; B33Y 40/20; B33Y 70/00; C08F 232/08; C09D 145/00; B29K 2105/0014

(57) ABSTRACT

Provided herein is method of making a three-dimensional object (31) by stereolithography, comprising: (a) providing a polymerizable liquid comprising: (i) a light polymerizable component; (ii) a cyclic olefin monomer and/or prepolymer, (iii) an inhibited ring-opening metathesis polymerization (ROMP) catalyst, and (iv) a photoinitiator; (b) producing a three-dimensional intermediate from said polymerizable liquid by stereolithography (11); (c) optionally cleaning (12) said intermediate; and (d) heating (13) a surface of said three-dimensional intermediate to activate the inhibited ROMP catalyst, polymerize the cyclic olefin monomer and/or prepolymer by frontal ring-opening metathesis polymerization and form said three-dimensional object. Resins, build platforms (20) and apparatus useful for performing the method are also provided.

### FIELD OF THE INVENTION

The present invention concerns methods and apparatus for producing objects by additive manufacturing.

### BACKGROUND OF THE INVENTION

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of the growing object through a light transmissive window, or “top-down” techniques, where light is projected onto the resin on top of the growing object, which is then immersed downward into the pool of resin.

The recent introduction of a more rapid stereolithography technique known as continuous liquid interface production (CLIP), coupled with the introduction of “dual cure” resins for additive manufacturing, has expanded the usefulness of stereolithography from prototyping to manufacturing (see, e.g., U.S. Pat. Nos. 9,211,678; 9,205,601; and U.S. Pat. No. 9,216,546 to DeSimone et al.; and also J. Tumbleston, D. Shirvanyants, N. Ermoshkin et al., Continuous liquid interface production of 3D Objects, Science 347, 1349-1352 (2015); see also Rolland et al., U.S. Pat. Nos. 9,676,963, 9,453,142 and 9,598,606).

Additional additive manufacturing techniques may further expand the variety of materials suitable for stereolithography.

U.S. Pat. No. 10,487,446 to Robertson et al. concerns the use of frontal ring-opening metathesis polymerization (FROMP) for production of fiber-reinforced composites by rapid polymerization of dicyclopentadiene with a propagating reaction wave sustained by the exothermic reaction. Fabric is stacked in layers, suffused with a mixture capable of frontal polymerization, and FROMP is initiated with a thermal stimulus.

US 2018/0327531 to Moore et al. makes use of FROMP in 3D printing by extruding a thermoset gel onto a heated glass slide.

### SUMMARY OF THE INVENTION

Provided herein according to some embodiments is method of making a three-dimensional object by stereolithography, comprising: (a) providing a polymerizable liquid comprising: (i) a light polymerizable component; (ii) a cyclic olefin monomer and/or prepolymer, (iii) an inhibited ring-opening metathesis polymerization (ROMP) catalyst, (iv) a photoinitiator, (v) optionally a diluent, (vi) optionally a pigment or dye, and (vii) optionally a filler; (b) producing a three-dimensional intermediate from said polymerizable liquid by stereolithography including irradiating said polymerizable liquid with light to form a solid polymer scaffold from said light polymerizable component, said intermediate having the same shape as, or a shape to be imparted to, said three-dimensional object; (c) optionally cleaning said intermediate (e.g., by washing, wiping (with a blade, absorbent, compressed gas, etc.), gravity draining, centrifugal separation of residual resin therefrom, etc., including combinations thereof); (d) heating a surface of said three-dimensional intermediate (e.g., to a temperature of from 150, 175, or 200° C. to 300, 400, or 450° C.), to activate the inhibited ROMP catalyst, polymerize the cyclic olefin monomer and/or prepolymer by frontal ring-opening metathesis polymerization and form said three-dimensional object; and (e) optionally, baking said three-dimensional object to further polymerize the cyclic olefin monomer and/or prepolymer.

In some embodiments, the inhibited ROMP catalyst comprises a complex of a transition metal catalyst such as a ruthenium, tungsten, or osmium catalyst, and an inhibitor thereof. In some embodiments, the transition metal catalyst comprises a ruthenium(II) catalyst such as a 2nd generation Grubbs catalyst. In some embodiments, the inhibitor comprises an alkyl phosphite.

In some embodiments, the diluent is present and is a light reactive/photopolymerizable diluent.

In some embodiments, the light polymerizable component comprises monomers and/or prepolymers with reactive end groups selected from the group consisting of: acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers.

In some embodiments, the light polymerizable component comprises monomers and/or prepolymers with reactive end groups selected from the group consisting of: acrylates, methacrylates, and a mixture thereof (e.g., a trifunctional methacrylate oligomer).

In some embodiments, the cyclic olefin monomer and/or prepolymer is selected from the group consisting of cyclopropene, cyclobutene, benzocyclobutene, cyclopentene, norbornene, norbornadiene, cycloheptene, cyclooctene, 7-oxanorbornene, 7-oxanorbornadiene, cyclodecene, 1,3-cyclooctadiene, 1,5-cyclooctadiene, 1,3-cycloheptadiene, [2.2.1]bicycloheptenes, [2.2.2]bicyclooctenes, norbornene, norbornadiene, ethylidene norbornene, dicyclopentadiene, vinyl norbornene, cyclohexenylnorbornenes, norbornene dicarboxylic anhydrides, cyclododecene, 1,5,9-cyclododecatriene, and a mixture of two or more thereof.

In some embodiments, the stereolithography is top-down or bottom-up stereolithography such as continuous liquid interface production (CLIP).

In some embodiments, the heating is carried out by contacting a heating element directly to the surface.

In some embodiments, the frontal ring-opening metathesis polymerization comprises polymerization propagating through the three-dimensional intermediate from the surface that is heated.

In some embodiments, the producing step is carried out on a build platform comprising a heating element, and wherein the heating step is carried out by heating the surface of the three-dimensional intermediate with said heating element.

Also provided is a three-dimensional object produced by a method as taught herein, said object comprising an interpenetrating network (IPN) of the light polymerizable component in polymerized form, and polymerized cyclic olefin monomer and/or prepolymer.

Further provided is a polymerizable liquid useful for forming a three-dimensional object by stereolithography, comprising: (i) a light polymerizable component; (ii) a cyclic olefin monomer and/or prepolymer; (iii) an inhibited ring-opening metathesis polymerization (ROMP) catalyst; (iv) a photoinitiator; (v) optionally a diluent; (vi) optionally a pigment or dye; and (vii) optionally a filler.

In some embodiments, the inhibited ROMP catalyst comprises a complex of a transition metal catalyst such as a ruthenium, tungsten, or osmium catalyst, and an inhibitor thereof. In some embodiments, the transition metal catalyst comprises a ruthenium(II) catalyst such as a 2nd generation Grubbs catalyst. In some embodiments, the inhibitor comprises an alkyl phosphite.

In some embodiments, the diluent is present and is a light reactive/photopolymerizable diluent.

In some embodiments, the light polymerizable component comprises monomers and/or prepolymers with reactive end groups selected from the group consisting of: acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers.

In some embodiments, the light polymerizable component comprises monomers and/or prepolymers with reactive end groups selected from the group consisting of: acrylates, methacrylates, and mixtures thereof (e.g., a trifunctional methacrylate oligomer).

In some embodiments, the cyclic olefin monomer and/or prepolymer is selected from the group consisting of cyclopropene, cyclobutene, benzocyclobutene, cyclopentene, norbornene, norbornadiene, cycloheptene, cyclooctene, 7-oxanorbornene, 7-oxanorbornadiene, cyclodecene, 1,3-cyclooctadiene, 1,5-cyclooctadiene, 1,3-cycloheptadiene, [2.2.1]bicycloheptenes, [2.2.2]bicyclooctenes, norbornene, norbornadiene, ethylidene norbornene, dicyclopentadiene, vinyl norbornene, cyclohexenylnorbornenes, norbornene dicarboxylic anhydrides, cyclododecene, 1,5,9-cyclododecatriene, and a mixture of two or more thereof.

Also provided is a build platform for an additive manufacturing apparatus, comprising: (a) a body having a generally planar build surface thereon; (b) an elevator coupler connected to said body; and (c) at least one heater operatively associated with said platform and configured to heat said build surface.

In some embodiments, the build platform includes: (d) a unique identifier (e.g., an NFC tag) connected to said body.

In some embodiments, the at least one heater comprises a plurality of independently activatable heaters positioned to heat different portions of said build surface.

In some embodiments, each of said at least one heater comprises a resistive heater, a thermoelectric device (e.g., a Peltier device), a thin-film heater, or a combination thereof.

In some embodiments, the elevator coupler comprises a rail, slot, clamp, clamp fixture, draw-in pin, or combination of any thereof.

In some embodiments, the body is comprised of aluminum.

Still further provided is a stereolithography apparatus comprising: (a) a build platform as taught herein; (b) an optically transparent member, said build surface of the build platform and said optically transparent member defining a build region therebetween; (c) a drive operatively associated with said build platform, the drive configured for advancing said build platform and said optically transparent member away from one another; and (d) a light source positioned beneath said optically transparent member and configured to polymerize a light polymerizable resin in the build region.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 provides an example scheme in which an object or objects may be additively manufactured on a build platform (11), then cleaned on the build platform (12), and then the build platform activated as a heater to directly heat the portion of the object adhered to the build platform (13). This advantageously insures good thermal contact between the heater/build platform, and the object(s) being heated.

FIGS. 2 to 4 provide non-limiting examples of build platform heater configurations. Like parts are assigned like numbers throughout.

FIG. 2 provides an example build platform (20) for an additively manufactured object (31) with a body having a build surface (21), mounting rails (22) as an elevator coupler for securing or positioning the platform on an elevator, optional draw-in pins (23) for further securing/coupling the platform to an elevator, and a unique identifier (24) such as an NFC tag, RFID tag, bar code, or the like, on the platform, for tracking usage of the platform or platform history during additive manufacturing and post-additive manufacturing steps. Heaters (25) are included, which are all electrically associated with an electrical connector (26), which electrical connector can be connected to an electrical supply (optionally with associated controller) to activate the heaters when it is desired to initiate FROMP in the object 31.

FIG. 3 provides an example build platform that is similar to FIG. 2, except that thin film heaters (25′, 25″) are connected to the surface of the platform body, and the heaters are individually controllable through multiple electrical connectors (26′). In this embodiment, individual heaters can be selectively activated, such that initiation of FROMP in the object (31) only requires activation of one heater (25′), and heating of the entire build surface is not required. If desired, a protective coat (27) may be included over the heaters, the protective coat preferably formed of a thin, thermally conductive material, such as aluminum (including alloys thereof), aluminum oxynitride (e.g., ALON®), sapphire, tempered glass, etc.

FIG. 4 provides an example build platform that is similar to FIGS. 2 and 3, except that Peltier heat pumps (25b) (also known as thermoelectric devices) are employed as the heaters, with the hot sides thereof contacting the underside of the build surface. While shown linked as in FIG. 2, the Peltier heat pumps could also be individually activatable, as in FIG. 3. A heat collector (29), in a configuration similar to a heat sink (e.g., an aluminum alloy body having multiple fins), can be connected to the cold side of the Peltier heat pumps to facilitate heat transfer to the hot sides thereof.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity. Where used, broken lines illustrate optional features or operations unless specified otherwise.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations of one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly-used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

“Shape to be imparted to” refers to the case where the shape of the intermediate object slightly changes between formation thereof and forming the subsequent three-dimensional product, typically by shrinkage (e.g., up to 1, 2 or 4 percent by volume), expansion (e.g., up to 1, 2 or 4 percent by volume), removal of support structures, or by intervening forming steps (e.g., intentional bending, stretching, drilling, grinding, cutting, polishing, or other intentional forming after formation of the intermediate product, but before formation of the subsequent three-dimensional product). The three-dimensional intermediate may also be cleaned, if desired, before further curing, and/or before, during, or after any intervening forming steps.

### 1. Resins.

Polymerizable liquid compositions curable by actinic radiation (typically light, and in some embodiments ultraviolet (UV) light) are provided to enable the present invention. The liquid (sometimes referred to as “liquid resin,” “ink,” or simply “resin” herein) may include a polymerizable monomer, particularly photopolymerizable and/or free radical polymerizable monomers (e.g., reactive diluents) and/or prepolymers (i.e., reacted or larger monomers capable of further polymerization), and a suitable initiator such as a free radical initiator.

Photoinitiators useful in the present invention include, but are not limited to, diphenyl(2,4,6-trimethylbenzoyl)phosphine oxide (TPO), phenylbis(2,4,6-trimethylbenzoyl)phosphine oxide (PPO), 2-isopropylthioxanthone and/or 4-isopropylthioxanthone (ITX), etc.

Light-polymerizable monomers and/or prepolymers. Sometimes also referred to as “Part A” of the resin, these are monomers and/or prepolymers that can be polymerized by exposure to actinic radiation or light. This resin can have a functionality of two or higher (though a resin with a functionality of one can also be used when the polymer does not dissolve in its monomer). A purpose of Part A is to “lock” the shape of the object being formed or create a scaffold for the one or more additional components (e.g., Part B). Importantly, Part A is present at or above the minimum quantity needed to maintain the shape of the object being formed after the initial solidification during photolithography. In some embodiments, this amount corresponds to less than ten, twenty, or thirty percent by weight of the total resin (polymerizable liquid) composition.

Examples of reactive end groups suitable for Part A constituents, monomers, or prepolymers include, but are not limited to: acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers.

An aspect of the solidification of Part A is that it provides a scaffold in which a second reactive resin component, termed “Part B,” can solidify during a second step, as discussed further below.

Heat-polymerizable monomers and/or prepolymers. Sometimes also referred to as “Part B,” these constituents may comprise, consist of or consist essentially of a mix of monomers and/or prepolymers that possess reactive end groups that participate in a second solidification reaction during or after the Part A solidification reaction.

In the present invention, the second component/Part B of the dual cure resin comprises cyclic olefin monomers and/or prepolymers (i.e., reacted or larger monomers capable of further polymerization) suitable for frontal ring-opening metathesis polymerization (FROMP), and a suitable ROMP catalyst for polymerization thereof. See, e.g., U.S. Pat. No. 10,487,446 to Robertson et al., and US 2018/0327531 to Moore et al., which are incorporated by reference herein.

Resins may be in any suitable form, including “one pot” resins and “dual precursor” resins (where cross-reactive constituents are packaged separately, and which may be identified, for example, as an “A” precursor resin and a “B” precursor resin). Note that, in some embodiments employing “dual cure” polymerizable resins, the part, following manufacturing, may be contacted with a penetrant liquid, with the penetrant liquid carrying a further constituent of the dual cure system, such as a reactive monomer, into the part for participation in a subsequent cure. Such “partial” resins are intended to be included herein. See, e.g., WO 2018/094131 (Carbon, Inc.), the disclosures of which are incorporated herein by reference.

Non-limiting examples of suitable cyclic olefin monomers and/or prepolymers include, but are not limited to, cyclopropene, cyclobutene, benzocyclobutene, cyclopentene, norbornene, norbornadiene, cycloheptene, cyclooctene, 7-oxanorbornene, 7-oxanorbornadiene, cyclodecene, 1,3-cyclooctadiene, 1,5-cyclooctadiene, 1,3-cycloheptadiene, [2.2.1]bicycloheptenes, [2.2.2]bicyclooctenes, norbornene, norbornadiene, ethylidene norbornene, dicyclopentadiene, vinyl norbornene, cyclohexenylnorbornenes, norbornene dicarboxylic anhydrides, cyclododecene, 1,5,9-cyclododecatriene, or a mixture of two or more thereof. See, e.g., U.S. Pat. Nos. 9,181,360 and 8,210,967, which are incorporated by reference herein.

ROMP catalysts. In some embodiments, the resin includes a ROMP catalyst (e.g., a ruthenium catalyst such as a 2nd generation Grubbs catalyst). Numerous examples of such catalysts are known, including but not limited to those described in U.S. Pat. No. 6,107,420 to Grubbs and Wilhelm and U.S. Pat. No. 9,610,572 to Grela and Czarnocki, which are incorporated by reference herein. See also US 2018/0327531 to Moore et al.

Examples of ROMP catalysts include, but are not limited to, a transition metal catalyst such as a ruthenium, tungsten, or osmium. In some embodiments, the ROMP catalyst comprises a ruthenium(II) catalyst. Examples of ruthenium (II) catalysts include, but are not limited to, dichloro [1,3-bis(2,4,6-trimethylphenyl)-2-imidazolidinylidene] (benzylidene) (tricyclohexylphosphine) ruthenium(II) (GC2), dichloro [1,3-bis(2,4,6-trimethylphenyl)-2-imidazolidinylidene] (indenylidene) (tricyclohexylphosphine)ruthenium(II), dichloro [1,3-bis(2,4,6-trimethylphenyl)-2-imidazolidinylidene] (indenylidene) (triisopropylphosphite) ruthenium(II), and a combination of two ore more thereof.

ROMP catalyst inhibitors. Examples of ROMP catalyst inhibitors include, but are not limited to, pyridine such as 4-dimethylaminopyridine (DMAP); limonene; alkyl phosphite such as a methyl phosphite (e.g., trimethyl phosphite), ethyl phosphite (e.g., triethyl phosphite), propyl phosphite (e.g., tripropyl phosphite, triisopropyl phosphite), and butyl phosphite (e.g., tri-n-butyl phosphite, tri-sec-butyl phosphite, tri-tert-butyl phosphite, triisobytyl phosphite); alkyl imidazole such as 1-methylimidazole and 1-octylimidazole; etc., including combinations thereof. Ligands such as aryl phosphine (e.g., triphenyl phosphine), isochinoline, pyrazine, etc., may be provided in combination with the inhibitor(s) to improve pot life. See, e.g., US 2013/0237675 to Drozdzak et al.; U.S. Pat. No. 10,487,446 to Robertson et al.; P'Poo, S. J., & Schanz, H.-J. (2007). Reversible Inhibition/Activation of Olefin Metathesis: A Kinetic Investigation of ROMP and RCM Reactions with Grubbs' Catalyst. Journal of the American Chemical Society, 129(46), 14200-14212; Robertson et al. (2017). Alkyl Phosphite Inhibitors for Frontal Ring-Opening Metathesis Polymerization Greatly Increase Pot Life. ACS Macro Lett. 6(6), 609-612.

The ROMP catalyst and inhibitor form an inhibited ROMP catalyst complex (also known as a latent precatalyst or inhibited precatalyst (see example scheme below)), which inhibited catalyst may be activated upon heat treatment (e.g., to a temperature of from 150, 175, or 200° C. to 300, 400, or 450° C.), in accordance with the present invention. In some embodiments, the inhibitor is present in the resin composition in a range of 0.1, 0.5, 1, 1.5 or 2 to 5, 8 or 10 molar equivalents (mol/mol) of the ROMP catalyst.

In some embodiments, the cyclic olefin monomers and/or prepolymers to catalyst ratio is 50,000:1, 20,000:1, or 10,000:1 to 5,000:1, 1,000:1, 500:1, or 250:1 mol/mol.

Diluents. Diluents as known in the art are compounds used to reduce viscosity in a resin composition, and may be light reactive/photopolymerizable or non-reactive diluents. Reactive diluents undergo reaction to become part of the polymeric network during light cure. In some embodiments, the reactive diluent may react at approximately the same rate as other reactive monomers and/or prepolymers in the composition.

Fillers. Any suitable filler may be used in connection with the present invention, depending on the properties desired in the part or object to be made. Thus, fillers may be solid or liquid, organic or inorganic, and may include reactive and non-reactive rubbers: siloxanes, acrylonitrile-butadiene rubbers; reactive and non-reactive thermoplastics (including but not limited to: poly(ether imides), maleimide-styrene terpolymers, polyarylates, polysulfones and polyethersulfones, etc.) inorganic fillers such as silicates (such as talc, clays, silica, mica), glass, carbon nanotubes, graphene, cellulose nanocrystals, etc., including combinations of all of the foregoing. Suitable fillers include tougheners, such as core-shell rubbers, as discussed below.

Tougheners. One or more polymeric and/or inorganic tougheners can be used as a filler in the present invention. The toughener may be uniformly distributed in the form of particles in the cured product. The particles could be less than 5 microns (μm) in diameter. Such tougheners include, but are not limited to, those formed from elastomers, branched polymers, hyperbranched polymers, dendrimers, rubbery polymers, rubbery copolymers, block copolymers, core-shell particles, oxides or inorganic materials such as clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization. Examples of block copolymers include the copolymers whose composition is described in U.S. Pat. No. 6,894,113 (Court et al., Atofina, 2005) and include “NANOSTRENTH®” SBM (polystyrene-polybutadiene-polymethacrylate), and AMA (polymethacrylate-polybutylacrylate-polymethacrylate), both produced by Arkema (King of Prussia, Pa.). Other suitable block copolymers include FORTEGRA® and the amphiphilic block copolymers described in U.S. Pat. No. 7,820,760B2, assigned to Dow Chemical. Examples of known core-shell particles include the core-shell (dendrimer) particles whose compositions are described in US20100280151A1 (Nguyen et al., Toray Industries, Inc., 2010) for an amine branched polymer as a shell grafted to a core polymer polymerized from polymerizable monomers containing unsaturated carbon-carbon bonds, core-shell rubber particles whose compositions are described in EP 1632533A1 and EP 2123711A1 by Kaneka Corporation, and the “KaneAce MX” product line of such particle/epoxy blends whose particles have a polymeric core polymerized from polymerizable monomers such as butadiene, styrene, other unsaturated carbon-carbon bond monomer, or their combinations, and a polymeric shell compatible with the epoxy, typically polymethylmethacrylate, polyglycidylmethacrylate, polyacrylonitrile or similar polymers, as discussed further below. Also suitable as block copolymers in the present invention are the “JSR SX” series of carboxylated polystyrene/polydivinylbenzenes produced by JSR Corporation; “Kureha Paraloid” EXL-2655 (produced by Kureha Chemical Industry Co., Ltd.), which is a butadiene alkyl methacrylate styrene copolymer; “Stafiloid” AC-3355 and TR-2122 (both produced by Takeda Chemical Industries, Ltd.), each of which are acrylate methacrylate copolymers; and “PARALOID” EXL-2611 and EXL-3387 (both produced by Rohm & Haas), each of which are butyl acrylate methyl methacrylate copolymers. Examples of suitable oxide particles include NANOPDX® produced by nanoresins AG. This is a master blend of functionalized nanosilica particles and an epoxy.

Core-shell rubbers. Core-shell rubbers are particulate materials (particles) having a rubbery core. Such materials are known and described in, for example, US Patent Application Publication No. 20150184039, as well as US Patent Application Publication No. 20150240113, and U.S. Pat. Nos. 6,861,475, 7,625,977, 7,642,316, 8,088,245, and elsewhere.

In some embodiments, the core-shell rubber particles are nanoparticles (i.e., having an average particle size of less than 1000 nanometers (nm)). Generally, the average particle size of the core-shell rubber nanoparticles is less than 500 nm, e.g., less than 300 nm, less than 200 nm, less than 100 nm, or even less than 50 nm. Typically, such particles are spherical, so the particle size is the diameter; however, if the particles are not spherical, the particle size is defined as the longest dimension of the particle.

In some embodiments, the rubbery core can have a glass transition temperature (Tg) of less than −25° C., more preferably less than −50° C., and even more preferably less than −70° C. The Tg of the rubbery core may be well below −100° C. The core-shell rubber also has at least one shell portion that preferably has a Tg of at least 50° C. By “core,” it is meant an internal portion of the core-shell rubber. The core may form the center of the core-shell particle, or an internal shell or domain of the core-shell rubber. A shell is a portion of the core-shell rubber that is exterior to the rubbery core. The shell portion (or portions) typically forms the outermost portion of the core-shell rubber particle. The shell material can be grafted onto the core or is cross-linked. The rubbery core may constitute from 50 to 95%, or from 60 to 90%, of the weight of the core-shell rubber particle.

The core of the core-shell rubber may be a polymer or copolymer of a conjugated diene such as butadiene, or a lower alkyl acrylate such as n-butyl-, ethyl-, isobutyl- or 2-ethylhexylacrylate. The core polymer may in addition contain up to 20% by weight of other copolymerized mono-unsaturated monomers such as styrene, vinyl acetate, vinyl chloride, methyl methacrylate, and the like. The core polymer is optionally cross-linked. The core polymer optionally contains up to 5% of a copolymerized graft-linking monomer having two or more sites of unsaturation of unequal reactivity, such as diallyl maleate, monoallyl fumarate, allyl methacrylate, and the like, at least one of the reactive sites being non-conjugated.

The core polymer may also be a silicone rubber. These materials often have glass transition temperatures below −100° C. Core-shell rubbers having a silicone rubber core include those commercially available from Wacker Chemie, Munich, Germany, under the trade name GENIOPERL®.

The shell polymer, which is optionally chemically grafted or cross-linked to the rubber core, can be polymerized from at least one lower alkyl methacrylate such as methyl methacrylate, ethyl methacrylate or t-butyl methacrylate. Homopolymers of such methacrylate monomers can be used. Further, up to 40% by weight of the shell polymer can be formed from other monovinylidene monomers such as styrene, vinyl acetate, vinyl chloride, methyl acrylate, ethyl acrylate, butyl acrylate, and the like. The molecular weight of the grafted shell polymer can be between 20,000 and 500,000.

One suitable type of core-shell rubber has reactive groups in the shell polymer which can react with an epoxy resin or an epoxy resin hardener. Glycidyl groups are suitable. These can be provided by monomers such as glycidyl methacrylate.

One example of a suitable core-shell rubber is of the type described in US Patent Application Publication No. 2007/0027233 (EP 1632533 A1). Core-shell rubber particles as described therein include a cross-linked rubber core, in most cases being a cross-linked copolymer of butadiene, and a shell which is preferably a copolymer of styrene, methyl methacrylate, glycidyl methacrylate and optionally acrylonitrile. The core-shell rubber is preferably dispersed in a polymer or an epoxy resin, also as described in the document.

Suitable core-shell rubbers include, but are not limited to, those sold by Kaneka Corporation under the designation Kaneka Kane Ace, including the Kaneka Kane Ace 15 and 120 series of products, including Kaneka Kane Ace MX 120, Kaneka Kane Ace MX 153, Kaneka Kane Ace MX 154, Kaneka Kane Ace MX 156, Kaneka Kane Ace MX170, Kaneka Kane Ace MX 257 and Kaneka Kane Ace MX 120 core-shell rubber dispersions, and mixtures of two or more thereof.

Additional resin ingredients. The liquid resin or polymerizable material can have solid particles suspended or dispersed therein. Any suitable solid particle can be used, depending upon the end product being fabricated. The particles can be metallic, organic/polymeric, inorganic, or composites or mixtures thereof. The particles can be nonconductive, semi-conductive, or conductive (including metallic and non-metallic or polymer conductors); and the particles can be magnetic, ferromagnetic, paramagnetic, or nonmagnetic. The particles can be of any suitable shape, including spherical, elliptical, cylindrical, etc. The particles can be of any suitable size (for example, ranging from 1 nm to 20 μm average diameter).

The particles can comprise an active agent or detectable compound as described below, though these may also be provided dissolved or solubilized in the liquid resin as also discussed below. For example, magnetic or paramagnetic particles or nanoparticles can be employed.

The liquid resin can have additional ingredients solubilized therein, including pigments, dyes, active compounds or pharmaceutical compounds, detectable compounds (e.g., fluorescent, phosphorescent, radioactive), etc., again depending upon the particular purpose of the product being fabricated. Examples of such additional ingredients include, but are not limited to, proteins, peptides, nucleic acids (DNA, RNA) such as siRNA, sugars, small organic compounds (drugs and drug-like compounds), etc., including combinations thereof.

Photoabsorbers. In some embodiments, polymerizable liquids for carrying out the present invention include a non-reactive pigment or dye that absorbs light, particularly UV light. Suitable examples of such light absorbers include, but are not limited to: (i) titanium dioxide (e.g., included in an amount of from 0.05 or 0.1 to 1 or 5 percent by weight), (ii) carbon black (e.g., included in an amount of from 0.05 or 0.1 to 1 or 5 percent by weight), and/or (iii) an organic ultraviolet light absorber such as a hydroxybenzophenone, hydroxyphenylbenzotriazole, oxanilide, benzophenone, thioxanthone, hydroxyphenyltriazine, and/or benzotriazole ultraviolet light absorber (e.g., Mayzo BLS1326) (e.g., included in an amount of 0.001 or 0.005 to 1, 2 or 4 percent by weight). Examples of suitable organic ultraviolet light absorbers include, but are not limited to, those described in U.S. Pat. Nos. 3,213,058; 6,916,867; 7,157,586; and 7,695,643, the disclosures of which are incorporated herein by reference.

Flame retardants. Flame retardants that may be included in the polymerizable liquids of the present invention may include monomers or prepolymers that include flame retardant group(s). For example, in some embodiments the constituents may be brominated, i.e., contain one, two, three, four or more bromine groups (—Br) covalently coupled thereto (e.g., with total bromine groups in an amount of from 1, 2, or 5% to 15 or 20% by weight of the polymerizable liquid). Flame retardant oligomers, which may be reactive or non-reactive, may also be included in the resins of the present invention. Examples include, but are not limited to, brominated oligomers such as ICL Flame Retardant F-3100, F-3020, F-2400, F-2016, etc. (ICL Industrial Products). See also U.S. 2013/0032375 to Pierre et al. Flame retardant synergists, which when combined with halogens such as bromine synergize flame retardant properties, may also be included. Examples include, but are not limited to, antimony synergists such as antimony oxides (e.g., antimony trioxide, antimony pentaoxide, etc.), aromatic amines such as melamine, etc. See U.S. Pat. No. 9,782,947. In some embodiments, the resin composition may contain synergists in an amount of from 0.1, 0.5 or 1% to 3, 4, or 5% by weight. In some embodiments, an antimony pentoxide functionalized with triethanolamine or ethoxylated amine may be used, which is available as BurnEX® colloidal additives such as BurnEX® A1582, BurnEX® ADP480, and BurnEX® ADP494 (Nyacol® Nano Technologies, Ashland, Massachussetts).

Matting agents. Examples of suitable matting agents include, but are not limited to, barium sulfate, magnesium silicate, silicon dioxide, an alumino silicate, alkali alumino silicate ceramic microspheres, alumino silicate glass microspheres or flakes, polymeric wax additives (such as polyolefin waxes in combination with the salt of an organic anion), etc., including combinations thereof.

### 2. Methods of Making.

Techniques for producing an intermediate object, or “green” intermediate, from resins by additive manufacturing are known. Suitable techniques include bottom-up and top-down additive manufacturing, generally known as stereolithography. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. See also U.S. Pat. Nos. 9,211,678; 9,205,601; and U.S. Pat. No. 9,216,546 to DeSimone et al. The disclosures of these patents and applications are incorporated by reference herein in their entirety.

A method of making a three-dimensional object by stereolithography may include: (a) providing a polymerizable liquid comprising: (i) a light (typically ultraviolet light) polymerizable component; (ii) a cyclic olefin monomer and/or prepolymer, (iii) an inhibited ring-opening metathesis polymerization (ROMP) catalyst, (iv) a photoinitiator, (v) optionally a diluent, (vi) optionally a pigment or dye, and (vii) optionally a filler; (b) producing a three-dimensional intermediate from said polymerizable liquid by stereolithography including irradiating said polymerizable liquid with light to form a solid polymer scaffold from said light polymerizable component, said intermediate having the same shape as, or a shape to be imparted to, said three-dimensional object; (c) optionally cleaning said intermediate (e.g., by washing, wiping (with a blade, absorbent, compressed gas, etc.), gravity draining, centrifugal separation of residual resin therefrom, etc., including combinations thereof); (d) heating a surface of said three-dimensional intermediate (e.g., to a temperature of from 150, 175, or 200° C. to 300, 400, or 450° C.), to activate the inhibited ROMP catalyst, polymerize the cyclic olefin monomer and/or prepolymer and form said three-dimensional object; and (e) optionally, baking said three-dimensional object to further polymerize the cyclic olefin monomer and/or prepolymer.

A method of making a three-dimensional object by bottom-up additive manufacturing as taught herein may include: (a) providing a build platform with a build surface and an optically transparent member, said build surface of the platform and said optically transparent member defining a build region therebetween; (b) filling said build region with a light polymerizable liquid as taught herein, said polymerizable liquid comprising a mixture of (i) a light (typically ultraviolet light) polymerizable first component, and (ii) a second solidifiable component comprising a cyclic olefin monomer and/or prepolymer, and an inhibited ROMP catalyst; (c) irradiating said build region with light through said optically transparent member to form a solid polymer scaffold from said first component and also advancing said build platform away from said optically transparent member to form a three-dimensional intermediate having the same shape as, or a shape to be imparted to, said three-dimensional object and containing said second solidifiable component carried in said scaffold in unsolidified and/or uncured form; (d) optionally cleaning said intermediate (e.g., by washing, wiping (with a blade, absorbent, compressed gas, etc.), gravity draining, centrifugal separation of residual resin therefrom, etc., including combinations thereof); (e) heating a surface of said three-dimensional intermediate (e.g., to a temperature of from 150, 175, or 200° C. to 300, 400, or 450° C.), to activate the inhibited ROMP catalyst, polymerize the cyclic olefin monomer and/or prepolymer and form said three-dimensional object; and (f) optionally, baking said three-dimensional object to further polymerize the cyclic olefin monomer and/or prepolymer.

In some embodiments, the additive manufacturing step is carried out by one of the family of bottom-up additive manufacturing methods sometimes referred to as as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (2016). Other examples of methods and apparatus for carrying out particular embodiments of CLIP include, but are not limited to: Batchelder et al., US Patent Application Pub. No. US 2017/0129169; Sun and Lichkus, US Patent Application Pub. No. US 2016/0288376; Willis et al., US Patent Application Pub. No. US 2015/0360419; Lin et al., US Patent Application Pub. No. US 2015/0331402; D. Castanon, S Patent Application Pub. No. US 2017/0129167. B. Feller, US Pat App. Pub. No. US 2018/0243976; M. Panzer and J. Tumbleston, US Pat App Pub. No. US 2018/0126630; K. Willis and B. Adzima, US Pat App Pub. No. US 2018/0290374; L. Robeson et al., PCT Patent Pub. No. WO 2015/164234 (see also U.S. Pat. Nos. 10,259,171 and 10,434,706); and C. Mirkin et al., PCT Patent Pub. No. WO 2017/210298 (see also US Pat. App. US 2019/0160733).

In some embodiments, CLIP employs features of a bottom-up three dimensional fabrication as described above, but the the irradiating and/or said advancing steps are carried out while also concurrently: (i) continuously maintaining a dead zone of polymerizable liquid in contact with said optically transparent member, and (ii) continuously maintaining a gradient of polymerization zone (such as an active surface) between said dead zone and said solid polymer and in contact with each thereof, said gradient of polymerization zone comprising said first component in partially-cured form. In some embodiments of CLIP, the optically transparent member comprises a semipermeable member (e.g., a fluoropolymer), and said continuously maintaining a dead zone is carried out by feeding an inhibitor of polymerization through said optically transparent member, thereby creating a gradient of inhibitor in said dead zone and optionally in at least a portion of said gradient of polymerization zone.

In some embodiments, upon heating a surface of the intermediate object, the frontal ring-opening metathesis polymerization propogates through the three-dimensional intermediate from the heated surface through the remainder of the object. Such heating of a surface may be carried out in some embodiments with a build platform comprising a heating element, which may be in direct contact with the three-dimensional intermediate surface upon which to initial FROMP. In this approach, the whole part need not be heated, which can minimize volatilization and mass loss of monomers. If it takes some time for the whole part to get to a temperature to initiate frontal polymerization, that provides time in which monomers can evaporate, leading to significant mass loss during the heating ramp. In some embodiments, heating a small area or surface of the three-dimensional intermediate may be sufficient to initiate curing of the whole part without the need for baking (though baking may still be carried out subsequently to further cure the object).

As noted, in some embodiments, an additional baking step may be carried out. In some embodiments the baking step may be at one temperature. In other embodiments, the baking may be at at least a first temperature and a second temperature, with the first temperature greater than ambient (room) temperature, the second temperature greater than the first temperature, and the second temperature less than 300° C. (e.g., with ramped or step-wise increases between ambient temperature and the first temperature, and/or between the first temperature and the second temperature). For example, the object may be heated in a stepwise manner at a first temperature of about 70° C. to about 150° C., and then at a second temperature of about 150° C. to 200 or 250° C., with the duration of each heating depending on the size, shape, and/or thickness of the intermediate. In another embodiment, the object may be cured by a ramped heating schedule, with the temperature ramped from ambient temperature through a temperature of 70 to 150° C., and up to a final temperature of 250 or 300° C., at a change in heating rate of 0.5° C. per minute, to 5° C. per minute. See, e.g., U.S. Pat. No. 4,785,075.

### 3. Build Platform and Apparatus.

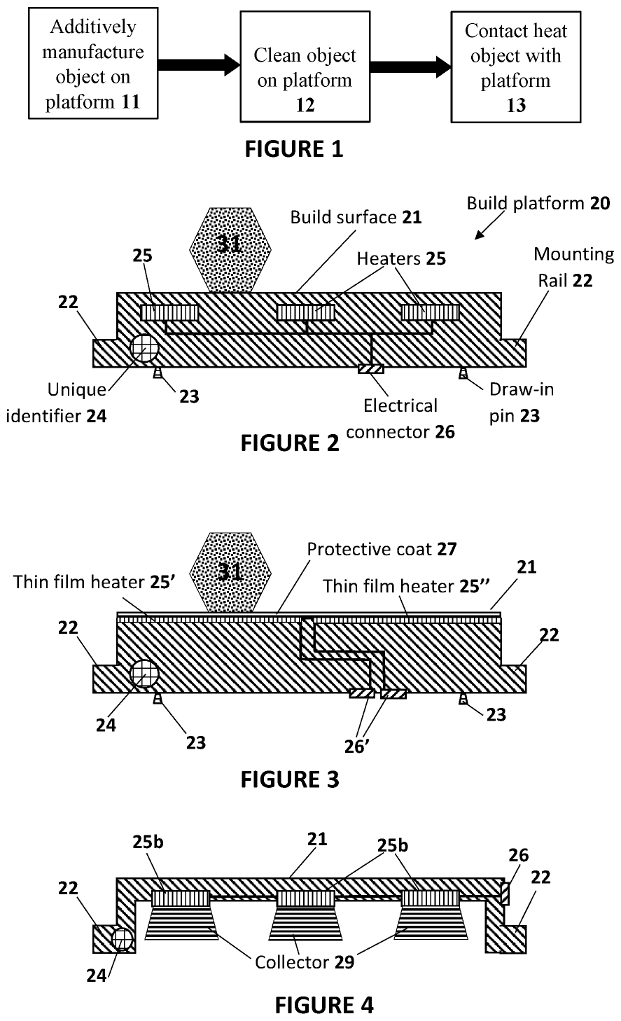

In some embodiments, a surface of the object may be directly contacted to a heater by making the build platform, itself, a heater. Thus, and as shown in the example scheme in FIG. 1, an object or objects may be additively manufactured on a build platform (11), then cleaned (e.g., by washing, spinning, blowing, or a combination thereof) on the build platform (12), and then the build platform activated as a heater to directly heat the portion of the object adhered to the build platform (13). This advantageously insures good thermal contact between the heater/build platform, and the object(s) being heated.

Non-limiting examples of build platform heaters are given in FIGS. 2-4, where like parts are assigned like numbers throughout. As shown in FIG. 2, a build platform (20) for an additively manufactured object (31) may include a body having a build surface (21), mounting rails (22) as an elevator coupler for securing or positioning the platform on an elevator, optional draw-in pins (23) for further securing/coupling the platform to an elevator, and a unique identifier (24) such as an NFC tag, RFID tag, bar code, or the like, on the platform, for tracking usage of the platform or platform history during additive manufacturing and post-additive manufacturing steps. Other details of build platforms are known in the art and described in, for example, G. Dachs, PCT Patent Application Publication No. WO 2020/069167 (published 2 Apr. 2020), which is incorporated by reference herein. In the embodiment of FIG. 2, heaters (25) such as resistive heaters are included, all electrically associated with an electrical connector (26), which electrical connector can be connected to an electrical supply (optionally with associated controller) to activate the heaters when it is desired to initiate FROMP in the object 31.

The embodiment of FIG. 3 is similar to that of FIG. 2, except that now thin film heaters (25′, 25″) are connected to the surface of the platform body, and the heaters are individually controllable through multiple electrical connectors (26′). In this embodiment, individual heaters can be selectively activated, such that initiation of FROMP in the object (31) only requires activation of heater 25′, and heating of the entire build surface is not required. If desired, a protective coat (27) may be included over the heaters, the protective coat preferably formed of a thin, thermally conductive material, such as aluminum (including alloys thereof), aluminum oxynitride (e.g., ALON®), sapphire, tempered glass, etc.

The embodiment of FIG. 4 is similar to that of FIGS. 2-3, except that now Peltier heat pumps (25b) (also known as thermoelectric devices) are employed as the heaters, with the hot sides thereof contacting the underside of the build surface. While shown linked as in FIG. 2, the Peltier heat pumps could also be individually activatable, as in FIG. 3. Also, if desired, a heat collector (29), in a configuration similar to a heat sink (e.g., an aluminum alloy body having multiple fins), can be connected to the cold side of the Peltier heat pumps to facilitate heat transfer to the hot sides thereof.

For bottom-up stereolithography, an apparatus may incorporate a build platform comprising a heater as taught herein, said apparatus including an optically transparent member, with the build surface of the build platform and the optically transparent member defining a build region therebetween. A drive operatively associated with the build platform may be provided, the drive configured for advancing the build platform (with an elevator, for example) and the optically transparent member away from one another. A light source may be positioned beneath the optically transparent member and configured to polymerize a light polymerizable resin in the build region.

The apparatus may include a vessel for containing the polymerizable liquid, with the optically transparent member positioned at the bottom of the vessel. See, e.g., U.S. Pat. Nos. 9,676,963, 9,453,142 and 9,598,606 to Rolland et al., which are incorporated by reference herein. At least one temperature sensor or thermocouple may be positioned in the vessel, along with at least one cooler (e.g., a Peltier cooler) to cool the polymerizable liquid during printing. The cooler may, for example, be in direct contact with a glass portion of a window cassette. See also U.S. Pat. No. 9,205,601 to DeSimone et al.

A controller (e.g., a computer with appropriate interface and program) may be provided, which operates the build platform, heater, and cooler, e.g., responsive to data such as current temperature of the polymerizable liquid as determined by the temperature sensor.

The present invention is further described in the following non-limiting examples.

### EXAMPLES

### Example 1: Frontal Ring Opening Metathesis Polymerization (FROMP) for Secondary Cure in a 3D Printed Acrylate or Methacrylate-Based Photopolymer Resin

A composition comprising methacrylate monomers and crosslinkers, strained olefin monomers, a ROMP catalyst, and inhibitor are 3D printed by stereolithography to form a 3D intermediate (“green”) object. Frontal polymerization of the strained olefin monomers is initiated by heating the intermediate object to form an interpenetrating network (IPN). ROMP reaction can be initiated by contact with a hot surface or baking as the heating step.

Initiating FROMP by contact of the green object with a hot surface was found to be unexpectedly beneficial to reduce mass loss during the second cure. Additional benefits may include lower energy use for curing methods as compared to oven baking.

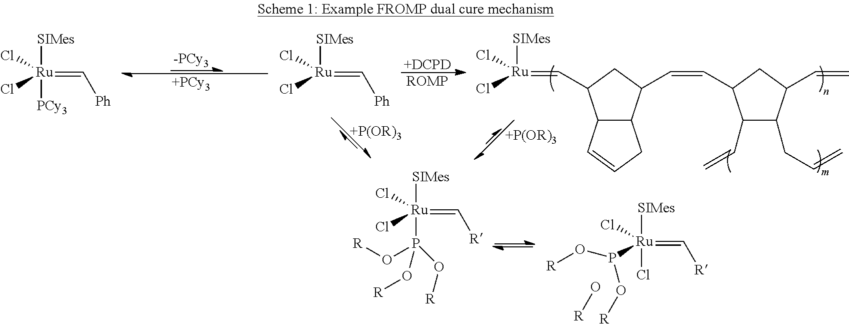

TABLE 1
Formulations Tested

| | A | B | C | D |
|---|---|---|---|---|
| Component | (wt %) | (wt %) | (wt %) | (wt %) |
| Dicyclopentadiene | 49.4 | 72.6 | 50.5 | 50.1 |
| Trifunctional methacrylate | 47.4 | 23.2 | 24.3 | 33.7 |
| oligomer (15,000 g/mol) | | | | |
| FA-512M | 0.0 | 0.0 | 21.4 | 12.7 |
| Stock solution of Grubbs | 2.2 | 3.2 | 2.8 | 2.6 |
| Catalyst ® 2^{nd}Generation, | | | | |
| inhibited with triethyl phosphite | | | | |
| (TEP), in toluene (1,3-Bis | | | | |
| (2,4,6-trimethylphenyl)-2- | | | | |
| imidazolidinylidene)dichloro | | | | |
| (phenylmethylene)(tricyclo- | | | | |
| hexylphosphine)ruthenium | | | | |
| (monomer to catalyst ratio is | | | | |
| 10,000:1 mol/mol) | | | | |
| TPO photoinitiator | 1.0 | 1.0 | 1.0 | 1.0 |

Structure of FA-512M (Hitachi):

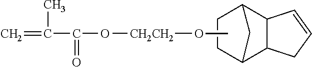

An important consideration for chemistries used in the formulations for stereolithography is green strength. A soft and tough trifunctional methacrylate oligomer was chosen as the UV crosslinker, though small molecular crosslinkers could also be used. Dicyclopentadiene was chosen as the strained olefin component, but other strained olefins such as cyclooctene, norbornene, and others known to undergo ROMP may be used. The components were mixed together in a Teflon mold and flood cured for 1 min per side.

Properties Comparing FROMP Vs. Oven-Bake:

### Curing Conditions:

Baking only—24 hours—30° C.; 2 hours—70° C.; 1.5 hours—170° C.
FROMP+bake—150° C. contact with 2 hotplates for 5 min followed by 170° C. for 1.5 hours

TABLE 2
Mechanical properties comparing oven-
baked and FROMP cured samples

| | A | A | | B | B | |
|---|---|---|---|---|---|---|
| | oven | FROMP + | % | oven | FROMP + | % |
| Sample | bake | bake | difference | bake | bake | difference |
| Modulus | 125 | 400 | +220% | 730 | 980 | +34% |
| EAB | 74 | ~15 | −80% | 75 | ~25 | −67% |

Polymerization of DPCP by FROMP and mass loss. The increase in modulus and decrease in elongation at break (EAB) in the FROMP method samples suggests a higher conversion and crosslink density compared to oven baked samples. The oven baked samples lost 20-30% of their mass due to a long heating schedule and slow initiation while the FROMP samples lost only 1 wt % when heated to 170° C. for 1.5 hours. Therefore, an advantage of FROMP may be a low mass loss dual cure material. The curing method may also be lower energy if baking may be reduced or not needed for the second cure.

The foregoing is illustrative of the present invention, and is not to be construed as limiting thereof. The invention is defined by the following claims, with equivalents of the claims to be included therein.

1. A method of making a three-dimensional object by stereolithography, comprising:
(a) providing a polymerizable liquid comprising: (i) a light polymerizable component; (ii) a cyclic olefin monomer and/or prepolymer, (iii) an inhibited ring-opening metathesis polymerization (ROMP) catalyst, (iv) a photoinitiator, (v) optionally a diluent, (vi) optionally a pigment or dye, and (vii) optionally a filler;
(b) producing a three-dimensional intermediate from said polymerizable liquid by stereolithography including irradiating said polymerizable liquid with light to form a solid polymer scaffold from said light polymerizable component, said intermediate having the same shape as, or a shape to be imparted to, said three-dimensional object, wherein said producing step is carried out on a build platform comprising a heating element;
(c) optionally cleaning said intermediate (e.g., by washing, wiping (with a blade, absorbent, compressed gas, etc.), gravity draining, centrifugal separation of residual resin therefrom, etc., including combinations thereof);
(d) heating a surface of said three-dimensional intermediate (e.g., to a temperature of from 150, 175, or 200° C. to 300, 400, or 450° C.) with said heating element; to activate the inhibited ROMP catalyst, polymerize the cyclic olefin monomer and/or prepolymer by frontal ring-opening metathesis polymerization and form said three-dimensional object; and
(e) optionally, baking said three-dimensional object to further polymerize the cyclic olefin monomer and/or prepolymer.

2. The method of claim 1, wherein said inhibited ROMP catalyst comprises a complex of a transition metal catalyst such as a ruthenium, tungsten, or osmium, and an inhibitor thereof.

3. The method of claim 2, wherein the transition metal catalyst comprises a ruthenium(II) catalyst such as a 2nd generation Grubbs catalyst.

4. The method of claim 2, wherein said inhibitor comprises an alkyl phosphite.

5. The method of claim 1, wherein said diluent is present and is a light reactive/photopolymerizable diluent.

6. The method of claim 1, wherein said light polymerizable component comprises monomers and/or prepolymers with reactive end groups selected from the group consisting of: acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers.

7. The method of claim 1, wherein said light polymerizable component comprises monomers and/or prepolymers with reactive end groups selected from the group consisting of: acrylates, methacrylates, and mixture thereof (e.g., a trifunctional methacrylate oligomer).

8. The method of claim 1, wherein the cyclic olefin monomer and/or prepolymer is selected from the group consisting of cyclopropene, cyclobutene, benzocyclobutene, cyclopentene, norbornene, norbornadiene, cycloheptene, cyclooctene, 7-oxanorbornene, 7-oxanorbornadiene, cyclodecene, 1,3-cyclooctadiene, 1,5-cyclooctadiene, 1,3-cycloheptadiene, [2.2.1]bicycloheptenes, [2.2.2]bicyclooctenes, norbornene, norbornadiene, ethylidene norbornene, dicyclopentadiene, vinyl norbornene, cyclohexenylnorbornenes, norbornene dicarboxylic anhydrides, cyclododecene, 1,5,9-cyclododecatriene, and a mixture of two or more thereof.

9. The method of claim 1, wherein said stereolithography is top-down or bottom-up stereolithography such as continuous liquid interface production (CLIP).

10. The method of claim 1, wherein the heating is carried out by contacting said heating element directly to the surface.

11. The method of claim 1, wherein the frontal ring-opening metathesis polymerization comprises polymerization propagating through the three-dimensional intermediate from the surface that is heated.

12-28. (canceled)
